(19) United States
(12) Patent Application Publication
(10) Pub. No.: US 2024/0376945 A1
(43) Pub. Date: Nov. 14, 2024

(54) BRAKE CALIPER OF A DISC FOR A DISC BRAKE

(71) Applicant: BREMBO S.P.A., Curno (Bergamo) (IT)

(72) Inventor: Silvia NESI, Curno (Bergamo) (IT)

(73) Assignee: BREMBO S.p.A., Curno (Bergamo) (IT)

(21) Appl. No.: 18/557,407

(22) PCT Filed: Apr. 27, 2022
(86) PCT No.: PCT/IB2022/053884

§ 371 Date: Oct. 26, 2023

(30) Foreign Application Priority Data
Apr. 27, 2021 (IT) 102021000010610

(51) Int. Cl. F16D 65/095; F16D 55/00

(52) U.S. Cl. CPC F16D 65/095; F16D 2055/0016; F16D 2055/002

(57) ABSTRACT

A brake caliper arranged straddling a braking band of a brake disc has first braking surface and second braking surface and a caliper body having a first caliper body portion facing the first braking surface, a second caliper body portion facing the second braking surface, and a bridge connecting the first and second caliper body portions. An outer caliper body surface faces away from the braking band. At least one of the first and second caliper body portions accommodates a thrust element. A light lamella protruding from the outer caliper body surface has a plate having two opposite plate surfaces, and plate edges. The plate has a predefined plate thickness and a side edge directed at the caliper body. The light lamella has a lighting body having a light source and transmitting, when activated, light radiation into the plate thickness so that the light radiation is distributed by the two opposite plate surfaces and/or the plate edges.

The present invention relates to a caliper for a disc brake, for example for a motor vehicle, as well as a control system and a motor vehicle comprising such a disc brake caliper.

In particular, in a disc brake, the brake caliper is arranged straddling the peripheral outer margin of a brake disc. The brake caliper usually comprises a body having two elongated elements, or portions, which are arranged so as to face opposite braking surfaces of a disc. Clutch pads are provided arranged between each elongated element of the caliper and the braking surfaces of the brake disc. At least one of the elongated elements of the caliper body has at least one cylinder adapted to accommodate a hydraulic piston capable of applying a thrust action to the pads, abutting them against the braking surfaces of the disc to apply a braking action to the vehicle.

The brake calipers usually are constrained to a support structure which remains firmly connected to the vehicle, such as, for example a suspension of a vehicle, more particularly a fork or swingarm of the suspension of a motor vehicle.

In a conventional arrangement, one of the two elongated elements has two or more attachment portions of the caliper body to the support structure, for example by providing slots or eyelets, for example arranged axially, or through holes, for example arranged radially, adapted to receive screws for fixing the caliper, which are accommodated with the ends thereof in threaded holes provided on the caliper support.

In a conventional caliper body construction, the elongated elements arranged facing the braking surfaces of the disc are connected together by bridge-like elements arranged straddling the disc.

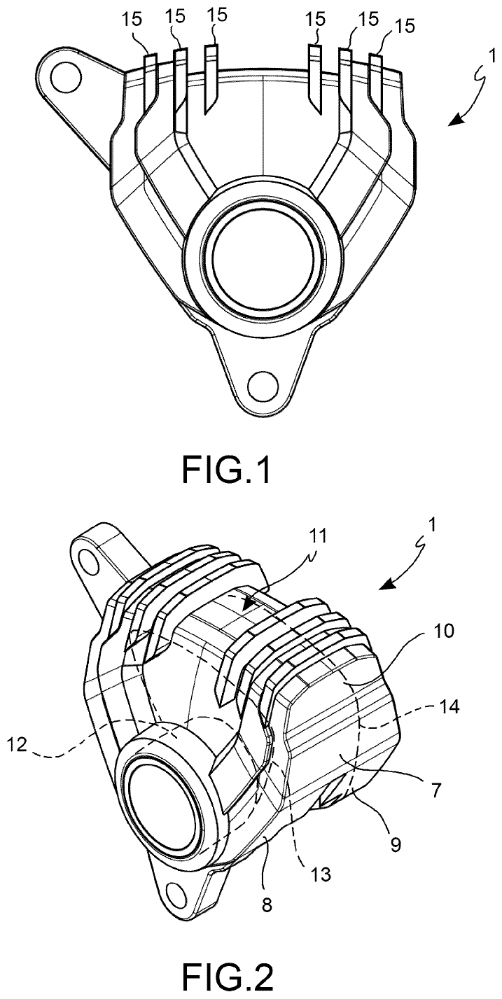

A caliper body of this type is described in JP2008045737A. FIG. 1 of JP2008045737A shows a caliper body of the floating caliper type, placed straddling a brake disc. This caliper body comprises two elongated elements, the ends of which are mutually connected by bridges.

The caliper comprises various components mounted to the body, such as pistons, seals, bleed devices and brake fluid feeding pipes.

Conventionally, the caliper body is made of metal, such as, for example aluminum or aluminum alloy or cast iron. The caliper body can be obtained by casting, but also by mechanical stock removal machining, as well as forging.

Desiring to stop or decelerate the vehicle, the driver applies a force to the brake pedal, in the case of a motor vehicle. Such a force on the brake pedal applies, through a brake pump, a brake fluid pressure which, through a pipe, is applied to the brake fluid present in the hydraulic circuit placed inside the caliper body to reach the cylinders where the pressure is applied to the bottom surface of the bottom of the pistons, thus forcing them to close against the pads, which in turn abut against the braking surfaces of the disc.

The pressure action of the brake fluid is also applied to the bottom wall of the cylinder, thus causing a reaction in the caliper body which deforms it away from the disc surfaces. This deformation of the caliper body leads to an increase in the piston stroke, and thus to an increase in the brake pedal stroke.

The caliper body also deforms as a function of the torque applied by the action of the pistons which, by abutting the pads against the braking surfaces of the disc, apply a deformation moment in directions which form torque arms with respect to the fixing points of the caliper body to the support thereof. These torques also deform the caliper body in a tangential and radial direction with respect to the disc, as well as in an axial direction.

Therefore, the caliper body must have sufficient structural rigidity so as to ensure that this deformation of the caliper body caused by the braking action is maintained within acceptable values, which in addition to avoiding damage to the braking system, do not create the feeling of a yielding braking system to the driver, thus resulting in an extra travel of the lever or pedal of the braking system and creating a “spongy” system feeling. This need urges having highly rigid structures for the bodies of the calipers, and thus increasing the overall size and weight thereof.

On the other hand, since the caliper body is constrained to the vehicle suspension and arranged straddling the disc, it is one of the unsprung masses intended to be reduced as much as possible in order to increase vehicle performance.

JP2008045737A shows a caliper on which a protective shield is mounted which carries a recessed LED or LCD monitor for showing the light warnings.

Furthermore, JP2008045737A shows a solution in which there is provided a light tube which is fastened to both ends of the caliper and extends around the braking surface externally facing the vehicle.

Further examples are given by publications US2009141514A1, U.S. Pat. Nos. 5,259,483, 7,144,142, US2004042227. All these solutions have light sources and also diffusers which are placed or recessed in covers or shields applied to the caliper bodies, or light sources surrounding the brake disc.

Therefore, there remains a strong need to propose the lighting of a wide area around the brake with at least one individual light source, and in particular, above the caliper body, away from the brake and from the disc, that is radially externally to the brake so as to illuminate at least a part of the vehicle and not just the brake or wheel alone, when required.

Simultaneously, there remains a strong need for this lighting source to be energy efficient.

These and further objects are achieved by a brake caliper as described in claim 1 appended hereto, as well as a motor vehicle according to claim 8 and a lighting system of a disc brake as described in claim 9.

Further objects, solutions and advantages are present in the embodiments described below and claimed in the dependent claims appended hereto.

Various embodiments of the invention are now described below through embodiments provided by mere way of non-limiting example, while in particular referencing the accompanying drawings, in which:

FIG. 1 shows a front view of a first embodiment of a brake caliper, that is looking at the caliper from the outer side thereof to the vehicle;

FIG. 2 shows an axonometric view of the brake caliper in FIG. 1, shown from the top and disc outlet side;

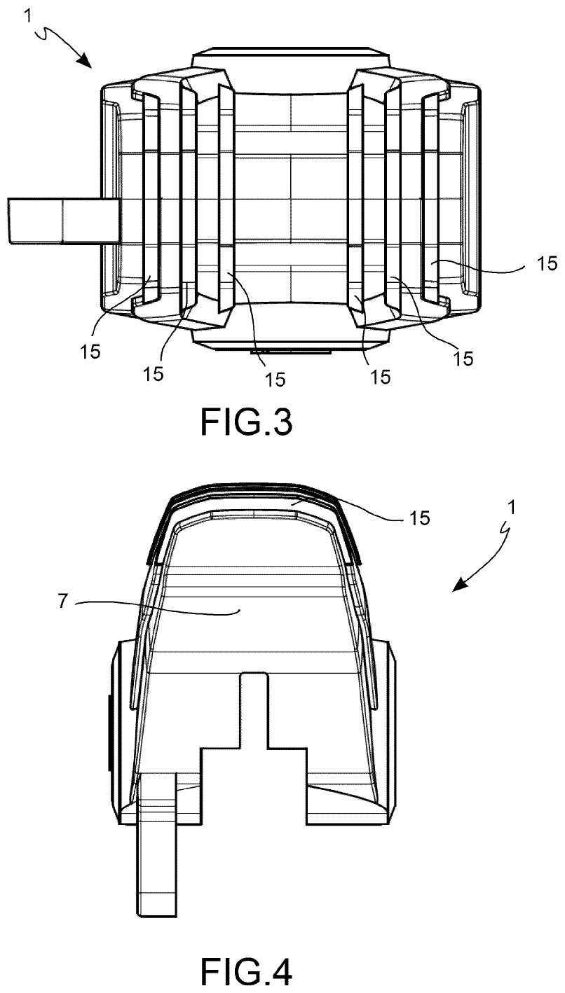

FIG. 3 shows a radially outer view of the caliper in FIG. 1, that is looking at the caliper towards the disc axis;

FIG. 4 shows a side view of the caliper in FIG. 1, that is in circumferential direction looking towards the disc outlet side;

FIG. 5 shows an axonometric view of a caliper shell adapted to be coupled to a caliper body in the drawing;

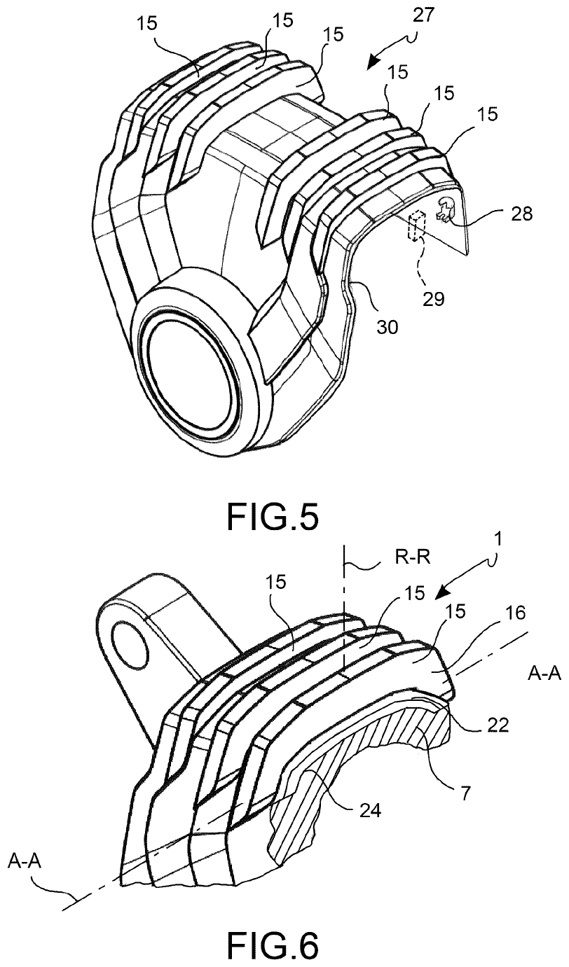

FIG. 6 shows an axonometric view of a local section of a brake caliper, noting a light lamella groove in which a light lamella is inserted;

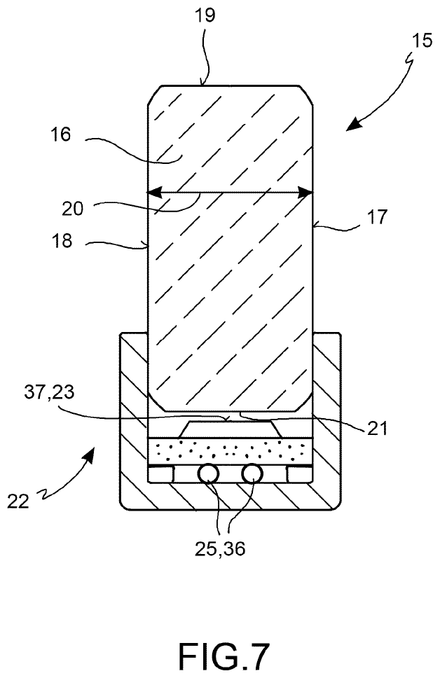

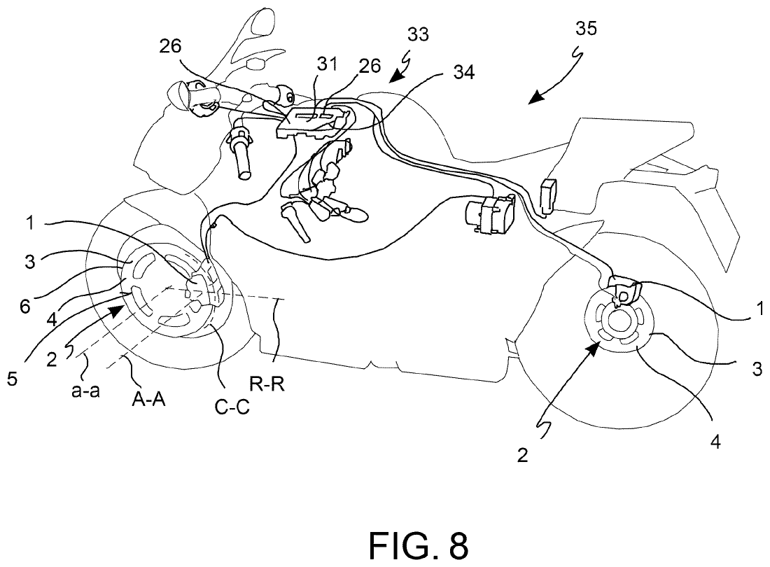

FIG. 7 shows an axonometric transparency view of a vehicle, in particular a motor vehicle, showing the braking system and the control unit of the vehicle, as well as the light source feeder or emitter of the brake calipers;

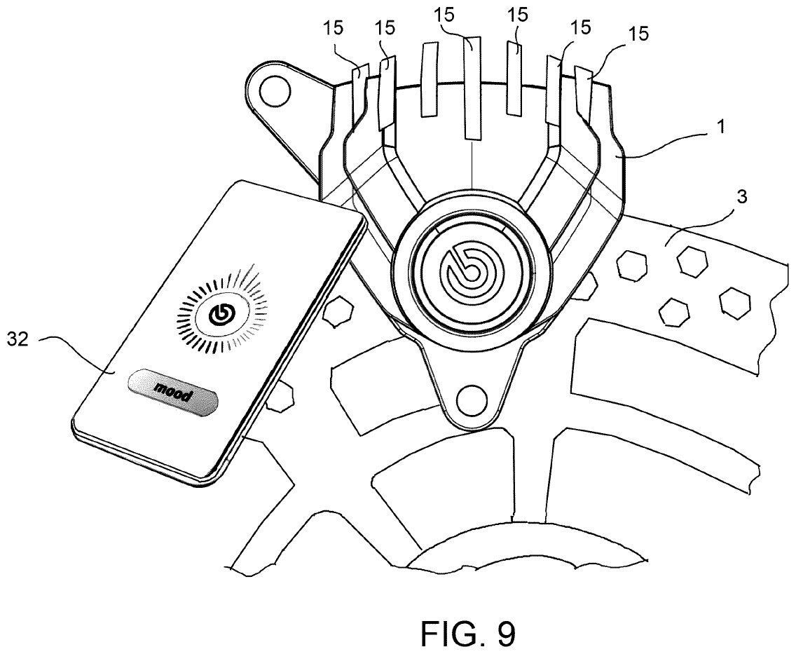

FIG. 9 shows an axonometric view against a dark background of a lit brake caliper to which a movable device, in particular a smartphone, for controlling the light lamellae, is placed side-by-side;

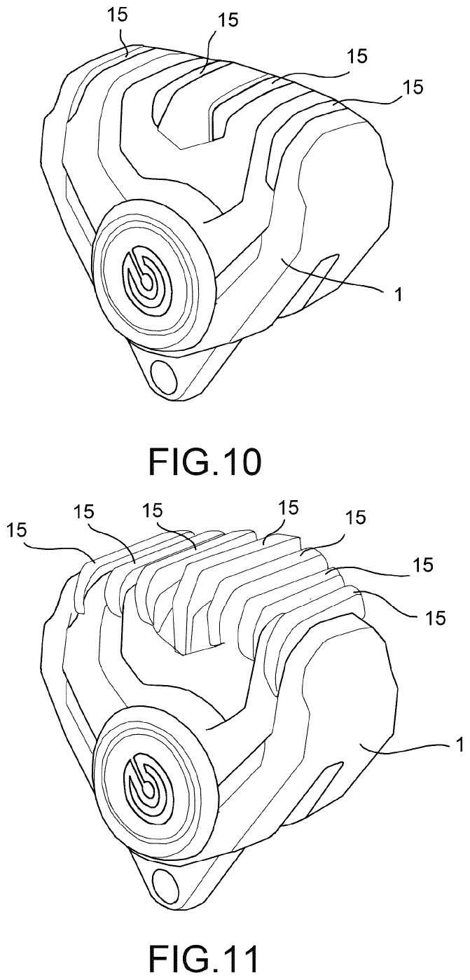

FIG. 10 shows an axonometric view against a dark background to highlight the light effect, of a brake caliper according to a further embodiment;

FIG. 11 shows an axonometric view against a dark background to highlight the light effect, of a brake caliper according to a further embodiment;

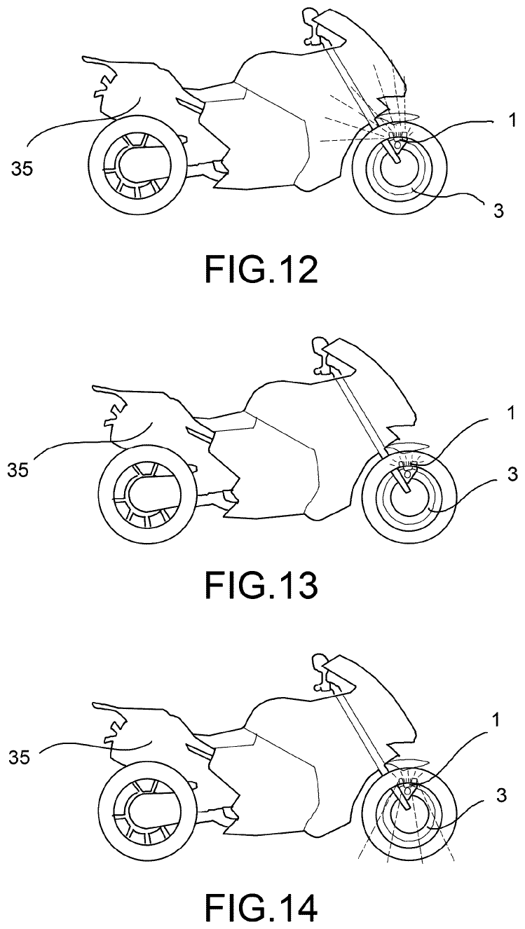

FIGS. 12, 13 and 14 show side views against a dark background to highlight the light effects, of motor vehicles on which a brake caliper according to three different embodiments and/or lighting, is frontally provided.

According to a general embodiment, a brake caliper 1 for a disc brake 2 is provided.

Said brake caliper 1 is adapted to be arranged straddling a braking band 3 of a brake disc 4 having at least one first and one second braking surface 5, 6 arranged opposite to each other.

Said disc 4 defines an axial direction A-A parallel to a rotation axis a-a thereof, a circumferential direction C-C parallel to one of said braking surfaces 5, 6 and orthogonal to said axial direction A-A, and a radial direction R-R orthogonal to the axial direction A-A and to the circumferential direction C-C, the latter defining an outer radial orientation RO when facing away from the rotation axis a-a of the brake disc 4.

Said brake caliper 1 comprises a caliper body 7.

Said caliper body 7 body comprises a first caliper portion 8 adapted to face the first braking surface 5.

Said caliper body 7 comprises a second caliper body portion 9 adapted to face the second braking surface 6.

Said caliper body 7 comprises at least one bridge 10 which connects said first caliper body portion 8 to said second caliper body portion 9.

Said caliper body 7 comprises an outer caliper body surface 11 arranged opposite to, that is facing away from, said braking band 3.

At least one of said first and second caliper body portion 8, 9 accommodates a thrust element 12 adapted to urge at least one pad 13, 14 to abut against at least one of said first or second braking surface 5, 6.

At least one light lamella 15 overhangingly protrudes from at least one portion of said outer caliper body surface 11.

Said light lamella 15 comprises at least one plate 16 made of transparent or translucent material having at least two opposite plate surfaces 17, 18 and plate edges 19 which join said plate surfaces 17, 18.

Said plate 16 comprises a predefined plate thickness 20 adapted to cause at least one light radiation to pass.

Said plate comprises at least one side edge facing said caliper body 21.

Said light lamella 15 further comprises at least one lighting body 22.

Said lighting body 22 comprises at least one light source, for example an LED 23 or an optical fiber 36, in particular an emission portion of light radiation 37 of the optical fiber 36.

Said lighting body 22 is associated with said side edge facing said caliper body 21 so as to transmit, when activated, the light radiation thereof into the plate thickness 20 so that said light radiation, or part thereof, is distributed by the opposite plate surfaces 17, 18 and/or by the plate edges 19 externally facing said caliper body 7.

According to an embodiment, said light source is an LED 23, that is a light emitting diode, or said light source is an optical fiber 36.

According to an embodiment, said light source is an emission portion of a light radiation 37 of an optical fiber 36.

According to an embodiment, said brake caliper 1 comprises at least one light lamella groove 24; and wherein said at least one light lamella groove 24 accommodates at least one portion of said side edge 21 and one portion of said lighting body 22.

According to an embodiment, said brake caliper 1 comprises at least one light lamella groove 24; and wherein said at least one light lamella groove 24 accommodates at least one portion of said side edge 21 and entirely said lighting body 22.

According to an embodiment, said brake caliper 1 comprises at least one light lamella groove 24; and wherein said at least one light lamella groove 24 accommodates at least one portion of said side edge 21 and one portion of said lighting body 22 and also an optical fiber cable or extension 25 which connects said lighting body 22 to a feeder or emitter 26.

According to an embodiment, said brake caliper 1 comprises at least one light lamella groove 24; and wherein said at least one light lamella groove 24 accommodates at least one portion of said side edge 21 and one portion of said lighting body 22 and also an optical fiber cable or extension 25 which connects said lighting body 22 to a feeder or emitter 26; said feeder or emitter 26 is controlled in controlled manner to actuate and regulate the intensity and/or color of said light source 23, 36 and/or the activation time.

According to an embodiment, said brake caliper 1 comprises at least one light lamella groove 24; and wherein said at least one light lamella groove 24 accommodates at least one portion of said side edge 21 and one portion of said lighting body 22 and also an optical fiber cable or extension 25 which connects said lighting body 22 to a feeder or emitter 26; said feeder or emitter 26 is controlled in controlled manner to actuate and regulate the intensity and/or color of said light source 23, 36 and/or the activation time according to an operating status of the vehicle.

According to an embodiment, said brake caliper 1 comprises a light lamella groove 24; and wherein said light lamella groove 24 is made in said caliper body 7 and accommodates at least one portion of said side edge 21 and one portion of said lighting body 22.

According to an embodiment, said brake caliper 1 comprises a caliper shell 27.

Said caliper shell 27 at least partially surrounds said caliper body 7, at least partially covering said outer caliper body surface 11, and couples to said caliper body 7.

Said brake caliper 1 comprises a light lamella groove 24; and wherein said light lamella groove 24 is made in said caliper shell 27 and accommodates at least one portion of said side edge 21 and one portion of said lighting body 22.

According to an embodiment, said brake caliper 1 comprises a caliper shell 27.

Said caliper shell 27 is snap-coupled to said caliper body 7.

According to an embodiment, said caliper shell 27 comprises at least one electrical connector 28 which, when the caliper shell 27 is connected to the caliper body 7, is electrically connected electrical caliper connector 29 provided in the caliper body 7.

According to an embodiment, said caliper shell 27 comprises at least one protective shell layer 30 which protects said at least one light lamella 15 from heat and stresses developed during a braking action.

According to an embodiment, said at least one plate 16 comprises polymethyl methacrylate (PMMA, abbreviated), for example also known as Plexiglas®.

According to an embodiment, said two opposite plate surfaces 17, 18 are arranged parallel to each other.

According to an embodiment, said at least one plate 16 is oriented in axial direction A-A, that is it arranges said plate surfaces 17, 18 so that they comprise an axial direction A-A.

According to an embodiment, said at least one plate 16 is at least two plates 16 arranged with plate surfaces 17 or 18 at least partially facing each other and parallel.

According to an embodiment, said at least one plate 16 is at least a plurality of plates 16.

According to an embodiment, said at least one plate 16 is at least a plurality of plates 16 arranged so that the distance between each plate 16 and the adjacent one is less than the protruding cantilevered extension of each of the two facing plates 16.

According to an embodiment, said at least one plate 16 is arranged longitudinal to said at least one bridge 10 and runs at least a portion of bridge 10.

According to an embodiment, said at least one plate 16 is arranged longitudinally to said at least one bridge 10 and runs all of said at least one bridge 10.

According to an embodiment, said plate edges 19 form a polygonal outline.

According to an embodiment, said plate edges 19 form a polygonal outline with rounded corners.

According to an embodiment, said at least one sheet 16 overhangingly protrudes from at least three sides of the caliper body 7.

According to an embodiment, said at least one plate 16 overhangingly protrudes with portions thereof in at least three orientations in at least two directions.

According to an embodiment, said at least one sheet 16 overhangingly protrudes from at least three sides of the caliper body 7, in particular in radial direction R-R and in the two opposite orientations of the axial direction A-A, towards the vehicle and away from the vehicle.

The present invention likewise relates to a disc brake comprising a brake caliper 1 according to any one of the above-described embodiments, and to a brake disc 4.

The present invention likewise relates to a motor vehicle 35 comprising a disc brake 2 which comprises at least one brake caliper 1 according to any one of the above-described embodiments.

The present invention likewise relates to a lighting system of a disc brake 33 comprising:
at least one brake caliper 1 according to any one of the above-described embodiments;
at least one light source feeder or emitter 26, operatively connected to said light source 23, 36;
at least one wireless connection card 31;
at least one mobile apparatus, for example a smartphone 32, which may be connected to said wireless connection card 31 to remotely control said light source feeder or emitter 26.

According to an embodiment, there is further comprised an operating connection of the at least one light source feeder or emitter 26 and at least one vehicle control unit 34 which receives the driving statuses of the vehicle and/or of the individual components of the vehicle, and in particular the various driving statuses of the braking system, and based on these statuses, transmits various light controls, such as intensity and/or duration and/or color, to said at least one light source feeder or emitter 26 to control said at least one light source, for example at least one LED or optical fiber 36, and emit a light radiation based on the driving statuses of the vehicle and/or of the individual components of the vehicle.

By virtue of the present invention, the lines at the sides and on the upper part characterizing the ribs of the caliper are reinterpreted with evolved plastic elements formed by dynamic solids and voids which are essential in the immediacy and formal consistency thereof.

The design aims to employ new technologies. Shape and function are enhanced by the LED/optical fiber technology which simultaneously becomes interface, directly dialoging with the user, or aesthetical choice, adapting to the tastes and preferences thereof.

By virtue of the wireless technologies, the brake caliper may indeed interface with the user, communicating data and information on the status of the vehicle and the caliper itself, such as, for example pad wear, thus signaling any anomalies.

The solution proposed may be integrated with GPS functions, and therefore serve to find the parked vehicle also by the emission of courtesy lights.

For the purpose of safety, the brake caliper may automatically block or release the vehicle by means of wireless connection, for example Bluetooth®, when the user is in the vicinity of the vehicle provided with this invention.

The caliper of the present invention may be directly integrated in the vehicle system, becoming functional with the signaling system.

Furthermore, the proposed solution may be adapted to the color scheme of the vehicle or the user's mood.

Therefore, the proposed caliper solution is “smart”, electronic, efficient, adaptable, empathetic.

### REFERENCES

1 brake caliper
2 disc brake
3 braking band
4 brake disc
5 first braking surface facing the vehicle
6 second braking surface externally facing the vehicle
7 caliper body
8 first caliper body portion
9 second caliper body portion
10 bridge
11 outer caliper body surface
12 thrust element
13 pad
14 pad
15 light lamella
16 plate
17 plate surface
18 plate surface
19 plate edge
20 plate thickness
21 side edge facing said caliper body
22 lighting body
23 LED (light emitting diode)
24 light lamella groove
25 optical fiber cable or extension
26 light source feeder or emitter
27 caliper shell
28 caliper shell connector
29 Electrical caliper connector
30 protective shell layer
31 wireless connection card
32 mobile apparatus, for example a smartphone
33 Disc brake lighting system
34 vehicle control unit
35 motor vehicle
36 optical fiber
37 emission portion of light radiation of the optical fiber
a-a disc rotation axis
A-A axial direction
T-T tangential direction
C-C circumferential direction
R-R radial direction

1-11. (canceled)

12. A brake caliper for a disc brake, said brake caliper being adapted to be arranged straddling a braking band of a brake disc having at least one first braking surface and at least one second braking surface arranged opposite to each other;
said brake disc defining an axial direction parallel to a rotation axis of the brake disc, a circumferential direction parallel to one of said first and second braking surfaces and orthogonal to said axial direction, and a radial direction orthogonal the axial direction and to the circumferential direction, the latter defining an outer radial orientation when directed away from the rotation axis of the brake disc;
said brake caliper comprising a caliper body;
said caliper body comprising a first caliper body portion adapted to face the first braking surface;
said caliper body comprising a second caliper body portion adapted to face the second braking surface;
said caliper body comprising at least one bridge that connects said first caliper body portion to said second caliper body portion;
said caliper body comprising an outer caliper body surface arranged opposite to, and facing away from, said braking band;
at least one of said first and second caliper body portions accommodating a thrust element adapted to urge at least one pad to abut against at least one of said first or second braking surface;
wherein
at least one light lamella overhangingly protrudes from at least one portion of said outer caliper body surface;
said at least one light lamella comprises at least one plate made of transparent or translucent material and having at least two opposite plate surfaces and plate edges that join said two opposite plate surfaces;
said at least one plate has a predefined plate thickness adapted to cause at least one light radiation to pass;
said at least one plate comprises at least one side edge directed at said caliper body;
said at least one light lamella further comprises at least one lighting body;
said lighting body comprises at least one light source; and wherein
said lighting body is associated with said side edge directed at said caliper body so as to transmit, when activated, a light radiation into the plate thickness so that said light radiation, or a part thereof, is distributed by the two opposite plate surfaces and/or by the plate edges externally facing said caliper body.

13. The brake caliper of claim 12, wherein
said at least one light source is an LED;
or wherein
said at least one light source is an optical fiber;
or wherein
said at least one light source is an emission portion of a light radiation of an optical fiber.

14. The brake caliper of claim 12, wherein
said brake caliper further comprises at least one light lamella groove, and wherein said at least one light lamella groove accommodates at least one portion of said side edge directed at said caliper body and a portion of said lighting body;
or wherein
said brake caliper further comprises at least one light lamella groove, and wherein said at least one light lamella groove accommodates at least one portion of said side edge directed at said caliper body and entirely said lighting body;
or wherein
said brake caliper further comprises at least one light lamella groove, and wherein said at least one light lamella groove accommodates at least one portion of said side edge directed at said caliper body and a portion of said lighting body and also an optical fiber cable or extension that connects said lighting body to a feeder or emitter;
or wherein
said brake caliper further comprises at least one light lamella groove, wherein said at least one light lamella groove accommodates at least one portion of said side edge directed at said caliper body and a portion of said lighting body and also an optical fiber cable or extension that connects said lighting body to a feeder or emitter, and wherein said feeder or emitter is controlled in controlled manner to actuate and regulate intensity and/or color of said light source and/or activation time;
or wherein
said brake caliper further comprises at least one light lamella groove, wherein said at least one light lamella groove accommodates at least one portion of said side edge directed at said caliper body and a portion of said lighting body and also an optical fiber cable or extension that connects said lighting body to a feeder or emitter, and wherein said feeder or emitter is controlled in controlled manner to actuate and regulate intensity and/or color of said light source and/or activation time according to an operating status of a motor vehicle.

15. The brake caliper of claim 12, wherein said brake caliper further comprises a light lamella groove, and wherein said light lamella groove is made in said caliper body and accommodates at least one portion of said side edge directed at said caliper body and a portion of said lighting body.

16. The brake caliper of claim 12, wherein
said brake caliper further comprises a caliper shell;
said caliper shell at least partially surrounds said caliper body, at least partially covering said outer caliper body surface, and couples to said caliper body;
said brake caliper further comprises a light lamella groove, and wherein said light lamella groove is made in said caliper shell and accommodates at least one portion of said side edge directed at said caliper body and a portion of said lighting body;
and/or wherein
said brake caliper further comprises a caliper shell, and wherein said caliper shell is snap-coupled to said caliper body, the brake caliper further comprising at least one of the following features:
said caliper shell comprises at least one electrical connector which, when the caliper shell is connected to the caliper body, is electrically connected to an electrical caliper connector provided in the caliper body;
said caliper shell comprises at least one protective shell layer that protects said at least one light lamella from heat and stresses developed during a braking action.

17. The brake caliper of claim 12, wherein said at least one plate comprises polymethyl methacrylate (PMMA).

18. The brake caliper of claim 12, wherein said two opposite plate surfaces are arranged parallel to each other.

19. The brake caliper of claim 12, wherein said at least one plate is oriented in the axial direction, arranging said two opposite plate surfaces so that the two opposite plate surfaces comprise the axial direction.

20. The brake caliper of claim 12, wherein said at least one plate is at least two plates arranged with the two opposite plate surfaces partially facing each other and parallel.

21. The brake caliper of claim 12, wherein
said at least one plate is at least a plurality of plates; or wherein
said at least one plate is at least a plurality of plates arranged so that a distance between each plate and an adjacent plate is less than a protruding cantilevered extension of each of two facing plates.

22. The brake caliper of claim 12, wherein
said at least one plate is arranged longitudinal to said at least one bridge and runs at least a portion of the bridge; or wherein
said at least one plate is arranged longitudinal to said at least one bridge and runs all of said at least one bridge.

23. The brake caliper of claim 12, wherein
said plate edges form a polygonal outline; or wherein
said plate edges form a polygonal outline with rounded corners.

24. The brake caliper of claim 12, wherein
said at least one plate overhangingly protrudes from at least three sides of the caliper body;
or wherein
said at least one plate overhangingly protrudes with portions thereof in at least three orientations in at least two directions;
or wherein
said at least one plate overhangingly protrudes from at least three sides of the caliper body, in particular in the radial direction and in two opposite orientations of the axial direction, towards a motor vehicle and away from the motor vehicle.

25. A motor vehicle comprising a disc brake comprising at least one brake caliper according to claim 12.

26. A lighting system of a disc brake comprising
at least one brake caliper according to claim 12;
at least one light source feeder or emitter, operatively connected to the at least one light source;
at least one wireless connection card; and
at least one mobile apparatus connectable to said wireless connection card to remotely control said at least one light source feeder or emitter.

27. The lighting system of claim 26, wherein said at least one mobile apparatus is a smartphone.

28. The lighting system of claim 26, further comprising an operating connection of the at least one light source feeder or emitter and at least one vehicle control unit that receives driving statuses of a motor vehicle and/or of individual components of the motor vehicle, and in particular various driving statuses of a braking system, and based on the statuses, transmits various light controls, including intensity, duration, and color to said at least one light source feeder or emitter to control said at least one light source and emit a light radiation based on the driving statuses of the motor vehicle and/or of the individual components of the motor vehicle.
